(19) United States
(12) Patent Application Publication
(10) Pub. No.: US 2011/0277230 A1
(43) Pub. Date: Nov. 17, 2011

(54) AUTOMATED WHEELCHAIR COMMODE SEAT APPARATUS

(76) Inventor: Gerald Williams, Montville, NJ (US)

(21) Appl. No.: 13/102,020

(22) Filed: May 5, 2011

Related U.S. Application Data
(60) Provisional application No. 61/395,315, filed on May 11, 2010.
(60) Provisional application No. 61/402,988, filed on Sep. 9, 2010.

(51) Int. Cl. A61G 7/02

(52) U.S. Cl. 4/480

(57) ABSTRACT

A commode seat for a conventional foldable wheelchair including a solid base that rests upon the horizontal seat support rails of a wheelchair when opened. The rectangular opening in the base is centered in the seat. The seat has a waste receptacle support pan mounted on the underside in alignment with the rectangular opening. The support pan is positioned to receive the similarly shaped removable waste receptacle. A U-shaped lifting plate is hinged attached onto the front of base and a sliding center section to cover waste receptacle opening is powered by direct current electric motors. Motors receive current from a power pack mounted on underside of seat. The seat can be operated by a seated invalid without assistance.

### CROSS-REFERENCE TO RELATED APPLICATIONS

This application claims the benefit of U.S. Provisional Patent Application 61/395,315, filed May 11, 2010, and U.S. Provisional Patent Application 61/402,988, filed Sep. 9, 2010, the disclosures of each of which are hereby incorporated by reference in their entirety.

### BACKGROUND

1. Field of the Invention

The present invention is designed to aid disabled individuals, particularly those who are wheelchair-bound, in addressing their hygienic needs, specifically facilitating urination and achieving bowel movements. This apparatus is integrally attachable to a conventionally designed wheelchair in a convenient and easily accessible manner. Disposal of waste material is quick and convenient for the associated care giving person.

2. Description Of The Prior Art

Non-ambulatory individuals confined to a wheelchair due to injury or disease still must cope with the everyday requirements associated with excretory functions. This requirement makes constant demands on a caregiver who is physically able to lift and move the invalid to a toilet or commode seat.

Patents have been granted on various designs to address these problems such as shown in U.S. Pat. No. 1,054,452 patented Feb. 25, 1913 to L. M. Sayen on a “Bed-Commode”; and U.S. Pat. No. 1,257,085 patented Feb. 19, 1918 to A. Mahoney on a “Sanitary Mattress For Invalids”; and U.S. Pat. No. 1,295,844 patented Mar. 4, 1919 to A. M. Bidwell on a “Mattress Basin-Drain”; and U.S. Pat. No. 1,372,505 patented Mar. 22, 1921 to C. Hanson on a “Mattress Attachment”; and U.S. Pat. No. 2,383,039 patented Aug. 21, 1945 to E. W. Bushnell and assigned to Berkley A. Thomas and Harry G. Marquis on a “Hospital Chair”; and U.S. Pat. No. 2,418,259 patented Apr. 1, 1947 to R. G. Harmanson on a “Hospital Bed Construction”; and U.S. Pat. No. 2,869,614 patented Jan. 20, 1959 to F. B. Wamsley on a “Combination Wheel Chair And Stretcher”; and U.S. Pat. No. 3,245,090 patented to S. M. Slimmer on Apr. 12, 1966 on a “Invalid Service Chair”; and U.S. Pat. No. 3,271,785 patented Sep. 13, 1966 to R. F. Du Bose on a “Convertible Wheel Chair And Commode”; and U.S. Pat. No. 3,568,219 patented Mar. 9, 1971 to S. Roberts on a “Support And Holder For Children's Toilet”; and U.S. Pat. No. 3,668,720 patented Jun. 13, 1972 to J. J. Wetzler on a “Mattress Support Structure”; and U.S. Pat. No. 3,863,276 patented Feb. 4, 1975 to K. M. Agnew et al and assigned to National Research Development Corporation on “Commodes”; and U.S. Pat. No. 4,048,679 patented Sep. 20, 1977 to W. A. Garnett on a “Toilet Seat”; and U.S. Pat. No. 4,296,506 patented Oct. 27, 1981 to N. Stout, Sr. et al and assigned to James A. Falborn and Richard M. Bird on an “Invalid Chair”; and U.S. Pat. No. 4,393,529 patented Jul. 19, 1983 to E. Britz on an “Invalid Chair”; and U.S. Pat. No. 4,510,631 patented Apr. 16, 1985 to M. Grady on a “Commode”; and U.S. Pat. No. 4,713,848 patented Dec. 22, 1987 to J. R. Demovs et al and assigned to Jean R. Demovs on a “Hygienic Wheelchair Seat for Extended Use”; and U.S. Pat. No. 4,837,868 patented Jun. 13, 1989 to J. A. Allen on “Commode Device For Invalid Patients”; and U.S. Pat. No. 4,944,922 patented to R. Terauchi on Sep. 11, 1990 on a “Urine-Collecting Apparatus For Wheel-Chair”; and U.S. Pat. No. 5,039,165 patented Aug. 13, 1991 to N. S. Rothman et al and assigned to The John Hopkins University on a “Wheelchair Toileting Module and Method”; and U.S. Pat. No. 5,077,845 patented Jan. 7, 1992 to K. Tokunaga et al and assigned to Sanyo Electric Co., Ltd. on a “Bed With Built-In Commode”; and U.S. Pat. No. 5,255,934 patented Oct. 26, 1993 to H. R. Wilson and assigned to Love Lift, L.P. on a “Wheelchair Seat Convertible To Toilet Seat”; and U.S. Pat. No. 5,285,535 patented Feb. 15, 1994 to D. A. Steward et al on a “Portable Toilet For Collapsible Incontinent Wheelchair”; and U.S. Pat. No. 5,381,573 patented Jan. 17, 1995 to J. MacSanz on an “Automatic Invalid Relief Facility”; and U.S. Pat. No. 5,394,570 patented Mar. 7, 1995 to T. P. Tzang on a “Toilet Seat Ring Automatic Raising Apparatus As Electromagnetically Actuated”; and U.S. Pat. No. 5,564,136 patented Oct. 15, 1996 to K. M. Cox on an “Incontinent Seat For A Wheelchair”; and U.S. Pat. No. 5,577,753 patented Nov. 26, 1996 to E. M. Pociask on a “Wheelchair And Commode Seat Therefor”; and U.S. Pat. No. 5,586,343 patented Dec. 24, 1996 to D. M. Mayle on a “Wheel Chair With A Removable Toilet Bowl And Seat”; and U.S. Pat. No. 5,604,943 patented Feb. 25, 1997 to M. Kimura et al and assigned to Kimura Industry Co., Ltd. on a “Bed System With Excreting Mechanism”; and U.S. Pat. No. 5,608,925 patented Mar. 11, 1997 to V. M. Porter on a “Wheelchair With Bed Pan”; and U.S. Pat. No. 6,176,508 patented Jan. 23, 2001 to P. Malassigne et al and assigned to The United States of America as represented by the Department of Veterans Affairs on an “Advanced Commode-Shower Wheelchair”; and U.S. Pat. No. 6,539,558 patented Apr. 1, 2003 to K. Shero on a “Multi-Function, Comfort Wheel Chair”; and U.S. Pat. No. 6,604,750 patented Aug. 12, 2003 to P. Malassigne et al and assigned to The United States of America as represented by the Department of Veterans Affairs on a “Commode And Shower Wheelchair”; and U.S. Pat. No. 6,623,022 patented Sep. 23, 2003 to P. Malassigne et al and assigned to The United States of America as represented by the Department of Veterans Affairs on a “Folding Commode And Shower Wheelchair”; and U.S. Pat. No. 6,733,024 patented May 11, 2004 to E. Savegnago on a “Commode Convertible Wheelchair Apparatus”; and U.S. Pat. No. 6,804,930 patented Oct. 19, 2004 to D. M. Stravitz and assigned to Saniquest Industries Corp. on “Waste Disposal Devices Including Cartridge Of Flexible Tubing”; and U.S. Pat. No. 6,851,251 patented Feb. 8, 2005 to D. M. Stravitz and assigned to Saniquest Industries Corp. on “Waste Disposal Devices”; and U.S. Pat. No. 6,901,974 patented Jun. 7, 2005 to R. S. Chomik et al and assigned to Playtex Products, Inc. on a “Composite Trash Container”; and U.S. Pat. No. 6,931,684 patented Aug. 23, 2005 to P. H. W. Henegar on a “Bed Having An Integral Refuse Disposal System”; and U.S. Pat. No. 6,941,733 patented Sep. 13, 2005 to R. S. Chomik et al and assigned to Playtex Products, Inc. on a “Waste Disposal Apparatus”; and U.S. Pat. No. 6,974,029 patented Dec. 13, 2005 to M. Morand et al and assigned to Moniteurs Angelcare Inc. on a “Cassette For Dispensing Pleated Tubing”; and U.S. Pat. No. 6,976,278 patented Dec. 20, 2005 to M. Oetting et al on a “Commode For Wheelchair”; and U.S. Pat. No. 6,994,247 patented Feb. 7, 2006 to D. C. Richards and assigned to Melrose Products Limited on a “Waste Disposal Device”; and U.S. Pat. No. 7,080,418 patented Jul. 25, 2006 to P. H. W. Henegar on an “Integral Refuse Disposal System”; and U.S. Pat. No. 7,520,518 patented Apr. 21, 2009 to C. J. Peterson et al and assigned to Invacare Corporation on a “Wheelchair”; and U.S. Pat. No. 7,600,817 patented Oct. 13, 2009 to K. L. Kramer et al and assigned to Hill-Rom Services, Inc. on a “Chair”; and U.S. Publication No. 2002/0078665 published Jun. 27, 2002 to N. E. Salman et al on a “Portable Packaging Device And Method For Forming Individually Packaged Articles”; and U.S. Publication No. 2002/0170275 published Nov. 21, 2002 to N. E. Salman et al and assigned to The Procter & Gamble Company on a “Portable Packaging Device And Method For Forming Individually Packaged Articles”; and U.S. Publication No. 2005/0028491 published Feb. 10, 2005 to D. M. Stravitz on “Waste Disposal Devices”; and U.S. Publication No. 2005/0126130 published to D. M. Stravitz on Jun. 16, 2005 and assigned to Saniquest Industries Corporation on “Waste Disposal Devices”; and U.S. Publication 2005/0183400 published Aug. 25, 2005 to D. M. Stravitz et al and assigned to Playtex Products, Inc. on a “Waste Disposal Device Including An External Actuation Mechanism To Operate A Cartridge”; and U.S. Publication No. 2005/0188661 patented Sep. 1, 2005 to D. M. Stravitz and assigned to Playtex Products, Inc. on a “Waste Disposal Device Including Rotating Cartridge Coupled To Lid”; and U.S. Publication No. 2005/0193691 published Sep. 8, 2005 to D. M. Stravitz et al on a “Waste Disposal Device Including A Rotatable Geared Rim To Operate A Cartridge”; and U.S. Publication No.2005/0274093 published Dec. 15, 2005 to D. M. Stravitz et al and assigned to Playtex Products, Inc. on a “Waste Disposal Device Including A Mechanism For Scoring A Flexible Tubing Dispensed From A Cartridge”; and U.S. Publication No. 2006/0037289 published Feb. 23, 2006 to R. S. Chomik et al an assigned to Playtex Products, Inc. on a “Waste Disposal Apparatus”.

Many specific approaches to solve this problem have been tried in the above patents ad patent applications. See for example, U.S. Pat. No. 3,245,090 to Slimmer (1966); U.S. Pat. No. 3,271,785 to Du Bose (1966). These older designs include disadvantages such as requiring specially designed wheelchairs or seats. Also, none of these prior art devices is suitable for foldable wheelchairs currently used throughout the healthcare industry. U.S. Pat. No. 4,296,506 to Stoute (1981) does show a design for this purpose; however, the drawings of this patent show an invalid chair having a flexible padded seat with a generally rectangular opening and a waste receiving receptacle disposed therebelow. While the device of Stoute et al was a major advance over the devices available contemporaneously, the use of a flexible seat provides inadequate support for those patients who spend long periods of time seated in the wheelchair. Moreover, the device requires a relatively high degree of physical dexterity to attend to and complete the manipulations involved in removing the container and closing the flap. Also particularly relevant is U.S. Pat. No. 4,713,848 to Domovs et al which shows a ridged, substantially flat, padded seat with an elongated opening of minimal width and a waste receiving receptacle disposed there below. However, this device has distinct disadvantages because the minimal width of the aperture could cause undesirable soiling of both the individual and the chair, thereby often requiring transfer of the person to clean the chair.

Most prior art devices have a number of disadvantages such as: (a) the seats are not designed to give the proper full support for invalids who spend many hours seated in a wheelchair, (b) in order to provide cleaning the invalid person must be transferred to another seating location, (c) the waste receptacles are quite difficult to remove and install from the commode and/or wheelchair, (d) the appearance of the overall construction is not conducive for use by an alert invalid especially when used outside of the home environment, (e) the designs shown in the prior art have not proven to be useful enough to be available commercially, (f) the prior art constructions are designed for use by a homebound patient in the home and the institutionalized patient in the institution and are not conducive to use by more active invalid persons and (g) prior art devices all require a significant level of physical dexterity on the part of the invalid to operate as designed. Thus what is needed is an improved wheelchair usable commode which solves the aforementioned defects.

### OBIECTS OF THE PRESENT INVENTION

It is an object of the present invention to provide a wheelchair commode seat that can be used by an invalid while requiring a limited amount of physical dexterity and with minimal caregiver assistance.

It is an object of the present invention to provide a wheelchair commode seat that can provide a wheelchair commode seat that offers comfort and support for extended time periods of usage.

It is an object of the present invention to provide a wheelchair commode seat that can be used in such a manner as to provide a wheelchair commode seat, where it is possible to take care of the perineal hygiene of the wheelchair bound person without transferring them from the chair.

It is an object of the present invention to provide a wheelchair commode seat that can be used in such a manner as to provide a wheelchair commode seat, where it is possible to clean the portion most likely soiled, with the person remaining seated in the chair.

It is an object of the present invention to provide a wheelchair commode seat that can be used to provide a wheelchair commode seat wherein the waste receptacle is very easy to install and remove.

It is an object of the present invention to provide a wheelchair commode seat that can be used in such a manner to provide a wheelchair commode seat having a subtle appearance that facilitates use by the user in any public environment.

It is an object of the present invention to provide a wheelchair commode seat that provides a unique design for a wheelchair commode seat that is lightweight and very easy to transport.

It is an object of the present invention to provide a wheelchair commode seat that includes a wheelchair commode seat having a limited parts and a very limited number of moving parts in order to facilitate manufacture and minimize maintenance requirements.

It is an object of the present invention to provide a wheelchair commode seat that fully enables the invalid to eat and drink without concern.

It is an object of the present invention to provide a wheelchair commode seat that allows the invalid to be less dependent on a caregiver.

It is an object of the present invention to provide a wheelchair commode seat that significantly adds to the safety and convenience of the invalid and associated caregiver since patient transfer is not required for urination or bowel movements.

It is an object of the present invention to provide a wheelchair commode seat apparatus that provides a highly reliable, lightweight, yet economical device for use by persons in almost any physical condition.

It is an object of the present invention to provide a wheelchair commode seat that has social significance in that it lowers cost of care in home, hospital and nursing home.

It is an object of the present invention to provide a wheelchair commode seat that grants the wheelchair-bound individual a great measure of personal independence.

It is an object of the present invention to provide a wheelchair commode seat that increases the ease of installation, removal and cleanup of the waste receptacle associated therewith.

It is an object of the present invention to provide a wheelchair commode seat apparatus that reduces chance of injury to the invalid and caregiver since patient does not have to be transferred in order to urinate or have bowel movements.

It is an object of the present invention to provide a wheelchair commode seat apparatus that reduces burden of an invalid person to family members and other caregivers, thus reducing the need for institutionalization.

It is an object of the present invention to provide a wheelchair commode seat that eliminates the problem of locating wheelchair accessible toilet facilities when away from the home environment.

It is an object of the present invention to provide a wheelchair commode seat apparatus that need not be limited to use with a standard wheelchair only, that is, it may be set in a pedestal base to be used on a motorized scooter for the handicapped, or in any chair base.

It is an object of the present invention to provide a wheelchair commode seat that can be made from fiberglass material or can be of metal or molded from a thermoplastic material for higher volume and lower cost production.

It is an object of the present invention to provide a wheelchair commode seat that makes use of two switches, preferably, but could be used with a single switch.

It is an object of the present invention to provide a wheelchair commode seat that includes a seat that can have cotton covers that are easily removed and laundered in view of the fact that normally wheelchair seated invalid persons do not use undergarments.

It is an object of the present invention to provide a wheelchair commode seat apparatus that is simple to use and inexpensive to manufacture.

### BRIEF DESCRIPTION OF THE DRAWINGS

While the invention is particularly pointed out and distinctly described herein, preferred embodiments are set forth in the following detailed description which may be best understood when read in connection with the accompanying drawings as described below:

FIG. 1 is a top plan view of an embodiment of the present invention;

FIG. 2 is a top plan view showing a lifting plate of an embodiment of the present invention;

FIG. 3 is a cross sectional view of the embodiment shown in FIG. 2 along lines 3/3;

FIG. 4 is a detailed exploded of a preferred embodiment of the present invention;

FIG. 5 is a right side plan view of an embodiment of the present invention shown in the open position;

FIG. 6 is a rear plan view of an embodiment of the present invention;

FIG. 7 is a front plan view of an embodiment of the present invention;

FIG. 8 is a top plan view showing an embodiment of the present invention showing a seat which can be raised in a substantially level plane;

FIG. 9 is a top plan view showing a lifting plate of the embodiment shown in FIG. 8;

FIG. 10 is a cross sectional view of the embodiment shown in FIG. 9 along lines 10/10;

FIG. 11 is a right side view of the embodiment shown in FIG. 8, in the open position;

FIG. 12 is a rear view of the embodiment shown in FIG. 8, in the raised position;

FIG. 13 is a front view of the embodiment shown in FIG. 8

FIG. 14 is a top plan view of an embodiment of the present invention showing a construction which can be manually operated by a caregiver;

FIG. 15 is a top plan view showing a lifting plate of the embodiment shown in FIG. 14;

FIG. 16 is a cross sectional view of the embodiment shown in FIG. 15 along lines 16/16;

FIG. 17 is a detailed exploded view of the embodiment shown in FIG. 14;

FIG. 18 is a left side plan view of the embodiment of the present invention shown in FIG. 14, in the open position;

FIG. 19 is a rear plan view of the embodiment shown in FIG. 14;

FIG. 20 is a front plan view of the embodiment shown in FIG. 14;

FIG. 21 is a top plan view of an embodiment of the present invention showing an apparatus having automatic operation;

FIG. 22 is a top plan view showing a lifting plate of the embodiment shown in FIG. 21;

FIG. 23 is a cross sectional view of the embodiment shown in FIG. 22 along lines 23/23;

FIG. 24 is a detailed exploded view of the embodiment shown in FIG. 21;

FIG. 25 is a left side plan view of the embodiment shown in FIG. 21, in the open position;

FIG. 26 is a rear plan view of the embodiment shown in FIG. 21;

FIG. 27 is a front plan view of the embodiment shown in FIG. 21.

### DETAILED DESCRIPTION OF THE PREFERRED EMBODIMENTS

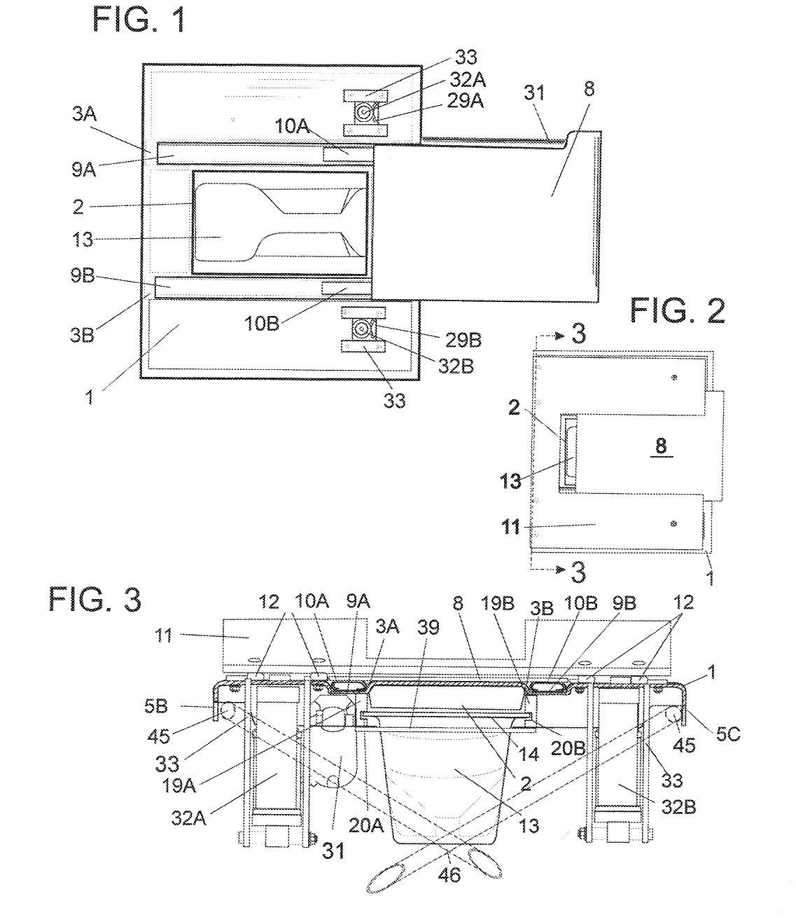

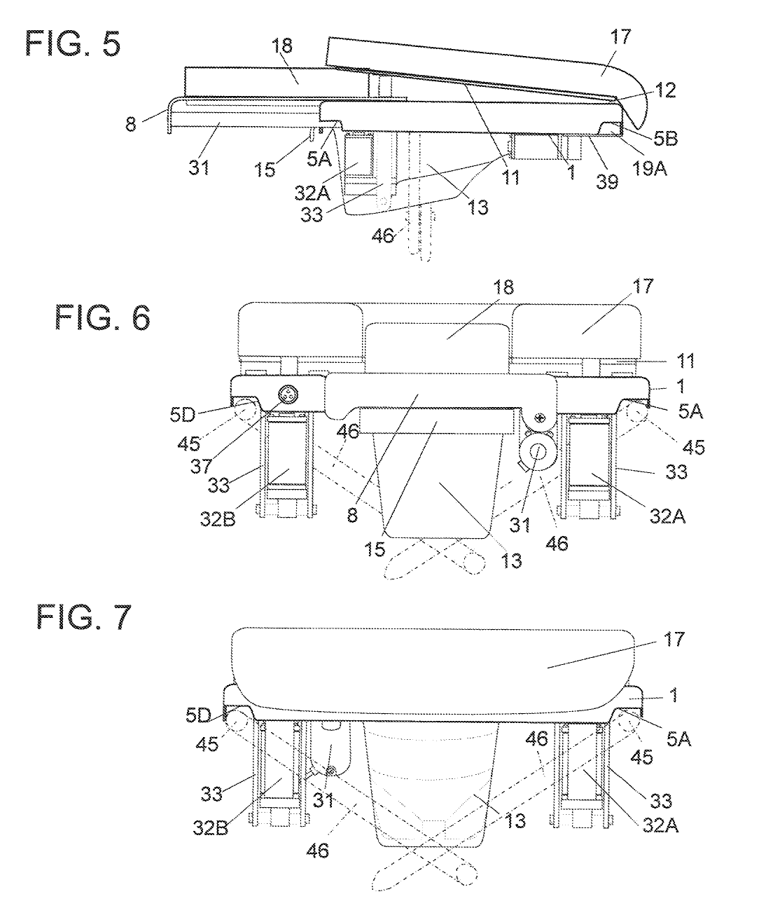

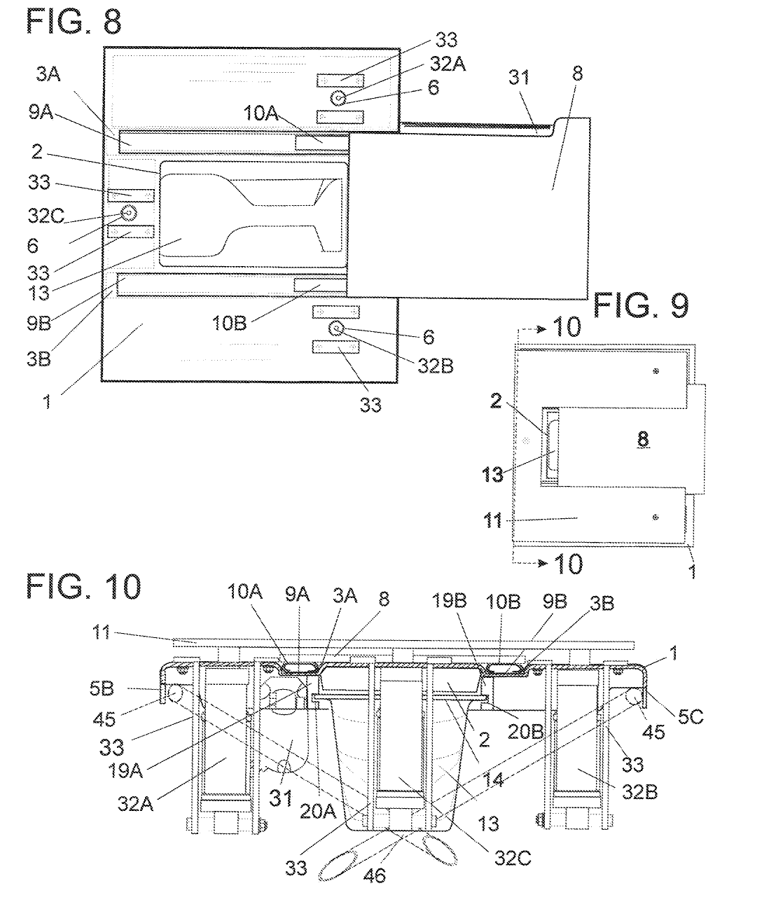

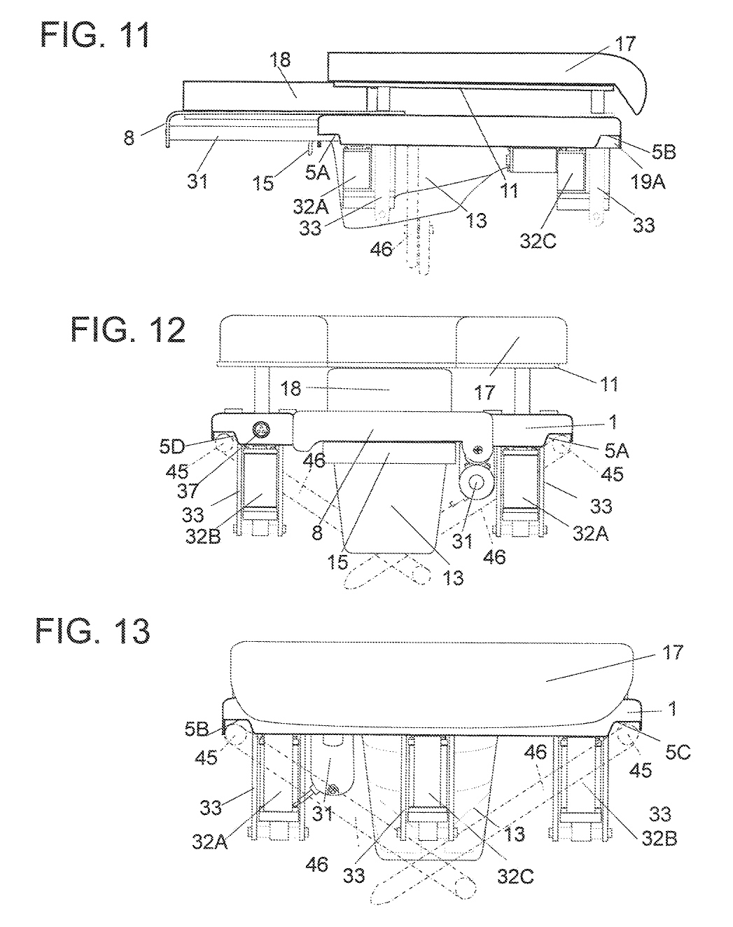

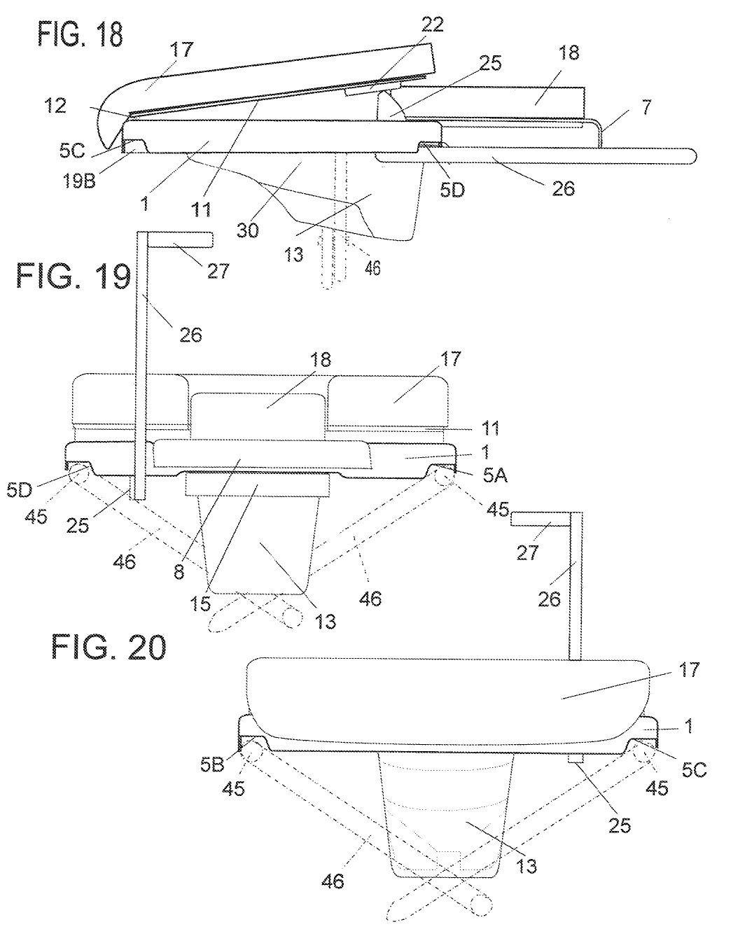

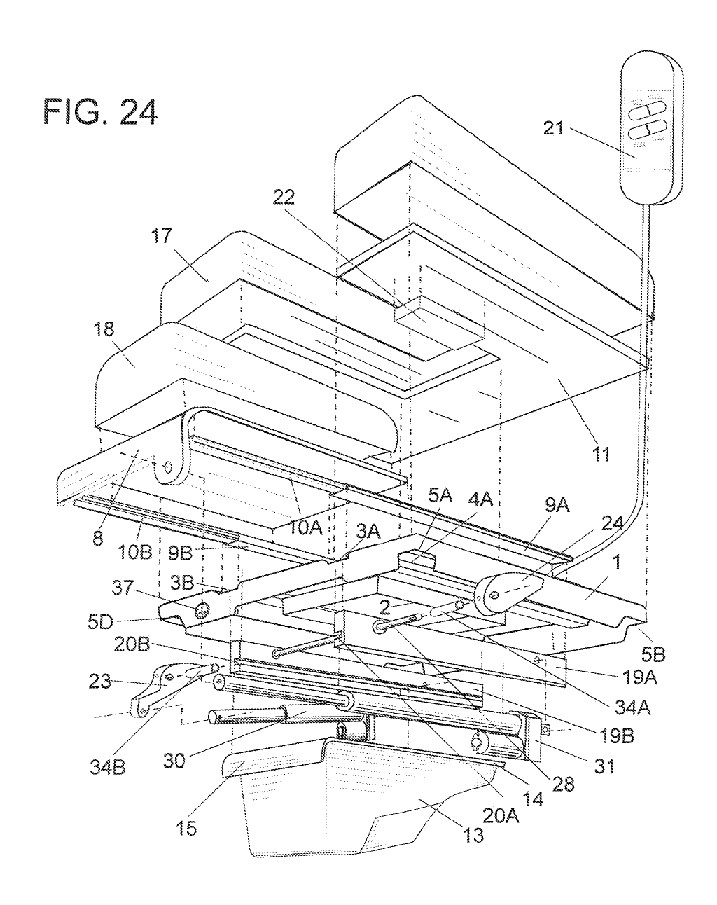

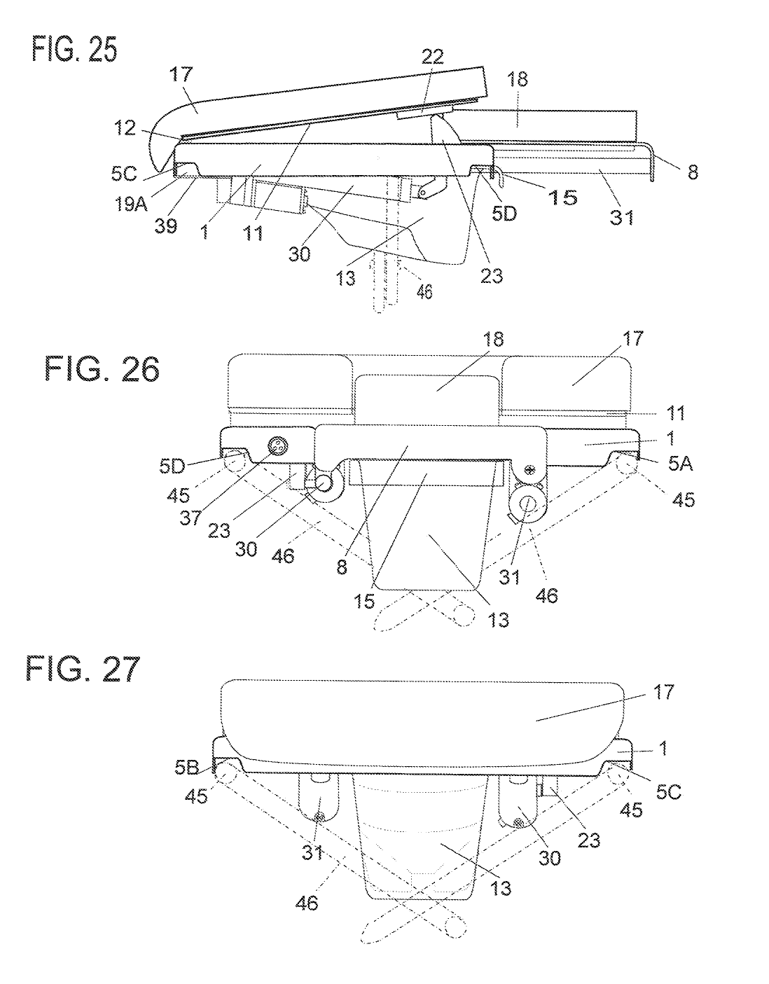

Embodiments of the apparatus of the present invention are illustrated with reference to FIGS. 1-7. Further embodiments of the apparatus of the present invention are illustrated with reference to FIGS. 8-27 and discussed later. The commode seat preferably replaces the standard canvas seat of a conventional wheelchair. Referring now to FIGS. 1-7, for convenience, the Base 1 is sized to fit on the horizontal Seat Support Bars 45 of a standard wheelchair. Cloth fabric portions, including the seat and cover, of embodiments of the present invention may be formed from any suitable fabric, such as nylon or cotton, but are preferably formed from bactericidal fabric(s), or bactericidal treated fabric(s) such as Cliniweave® a commercially available textile treatment designed for use in healthcare environments.

Base 1 is preferably molded of a fiberglass material with sufficient strength to support a person in a seated position, though it can of course be made of other materials such as metals including steel or aluminum. The edges of Base 1 are preferably angled downwardly for added structural strength. Centered in Base 1 is a rectangular molded Opening 2 The inner edge is formed oriented downwardly in order to add strength and to direct waste into a Waste Receptacle 13. Opening 2 is oriented extending substantially parallel to the right and left seat edges, of the proper size and location for Base 1 to function as a conventional toilet seat. This configuration is shown for example, in FIG. 3.

A Groove 3A is molded horizontally and parallel to the left side of Opening 2 in the top of Base 1. A Track 9A is bolted into Groove 3A, flush with the top of Base 1. Another Groove 3B is molded, horizontally and parallel, to the right side of Opening 2 in the top of Base 1. A Track 9B is bolted into Groove 3B, flush with the top of Base 1. Slides 10A and 10B slide to the rear when fully extended.

A Cover 8 is preferably attached to each sliding member 10A and 10B in an orientation extending there over. A Cover 8 is prefereably located approximately one inch short of covering Opening 2 on the front when in the closed position. This orientation and other similar orientations avoid injury to any person while seated in the chair. The rear of Cover 8 has a downward curved edge ending above Grooves 20A and 20B for Receptacle 13 this allows Receptacle 13 to be inserted and removed. There is a projection on the lower right corner of the curved edge of Cover 8 in order to facilitate affixing the cylinder of Actuator 31 thereto. This cylinder provides the means to move Cover 8 back and forth

As shown for example, in FIG. 2, a U-shaped Lifting Plate 11 is made of fiberglass and is attached to the front edge of Base 1. With Rubber Washers 12 inserted between Base 1 and Lifting Plate 11 to allow flexibility at the attachment point as the rear raises and lowers, with the open portion of the U-shaped portion oriented toward the rear. Plate 11 is about the same size as Base 1. The U-shaped portion is cut out to be capable of being vertically aligned with respect to Opening 2. A fitted Cushion 17 is attached to Plate 11 and has substantially the same configuration, when viewed from the top, as does Plate 11. Cushion 18 is of the required size and shape to fill in the open portion of the U-shaped portion and attaches to Cover 8. Both Cushions 17 and 18 are preferably made of a foam rubber padding and include a nylon covering, and may be attached by any conventional means (not shown) such as Velcro® material, or the like, in order to permit removal for transportation, cleaning or maintenance activities.

A Notch 5 is cut in each lower corner of Base 1 of a size to allow Base 1 to sit on the wheelchair Seat Rails 45 and for the side edge of Base 1 to extend below Seat Rail 45 which in turn secures the Base 1 to the wheelchair in a manner were it can not slide or fall off the frame.

Support rails 19A and 19B are made from elongated rectangular plastic bar material. Extending from the front to the rear of Base 1. Said Support members permanently affixed to the under side of Baseland running parallel to Opening 2 said members to have Grooves 20A and 20B machined in the lower side starting at a point just below were the down ward slope of Opening 2 ends. Said Grooves to be of a size to allow the insertion of Flanges 14 of waste Receptacle 13.

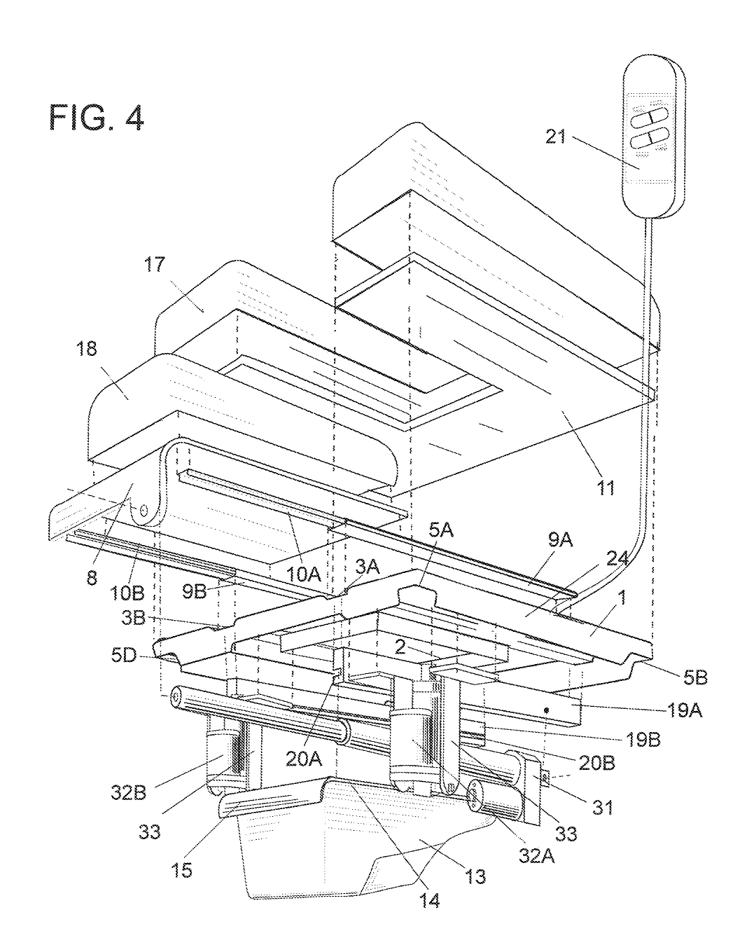

Removable Waste Receptacle 13, is preferably molded of a plastic material such as polyethylene and is shown, for example, in FIGS. 3 and 4. Receptacle 13 has a generally rectangular shaped entrance opening on top having a width slightly greater than Opening 2 and a length starting at the front of Opening 2 and ending at the rear edge of Base 1. The outward Flanges 14 on the top will permit Receptacle 13 to be temporally affixed under Opening 2 to Base 1, To allow Receptacle 13 to fit within the potentially obstructive elements of a foldable wheelchair. For example, in order accommodate the Cross Braces 46 of a conventional foldable wheelchair frame , the Receptacle 13 has a stepped configuration in side view with a shallow section in the front area to permit insertion with the upper “V” of the Cross Braces 46 of the wheelchair, and a second section having a greater depth and volume starting behind the Cross Braces 46.

The operation of the wheelchair commode is preferably accomplished by implementing commercially available 12 volt Mini linear Actuators with built in limit switches normally used in the medical field to supply movement for beds and other equipment, however any suitable control switch can be used. This equipment is utilized in order to provide dependability and to insure the ready availability of replacement parts. FIG. 1 shows the location of Apertures 29A and 29B they are located at the rear of Base 1 on the right and left side and are of a size to allow Brackets 33 to affix to the top of Base 1. Actuators 32A and 32B are used to raise and lower Lifting Plate 11. Are attached vertically to Brackets 33 on the underside of Base 1. When attached to Bracket 33 the Actuators 32A and 32B cylinders are ½″ above the top of Base 1 in the closed position so that preferably all the moving parts of the commode do not close tightly leaving a gap in the moving parts to avoid the possibility of injury. The rear of Lifting Plate 11 is then attached to Actuators 32A and 32B respectfully. Actuator 31 FIGS. 1 through 5 is included to facilitate linear motion of Cover 8. Actuator 31 cylinder in the closed position is attached to the downward projection on the right corner of Cover 8 and with Cover 8 extended ½″ in back of Base 1 Actuator 31 in a parallel plane with Base 1 is attached to Support 19A at the front of the seat Base 1.

Referring now to FIGS. 8, 9, 10,11,12, and 13, the seat can be raised in a substantially level position which is made possible by adding a third Actuator 32C in the center front of Base 1. If this option is chosen the Actuators 32A through 32C are preferably installed in the following manner. Brackets 33 is preferably installed in the top of Base 1 through slots (not shown) in the proper location to attach Actuators 32A through 32C through Apertures 6 which are in the location and of a size to allow the cylinders of Actuators 32A, 32B and 32c to move through Base 1 without interference. And at the same time adding stability when the Plate 11 is in the raised position. This is necessary as Lifting Plate 11 is not attached to Base 1 But is affixed to the cylinders of Actuators 32A, 32B and 32C If this option is chosen the battery and wiring has to be moved to an enclosure. Installed under Base 1 left side in front of Cross Brace 46.

Power is preferably supplied to Actuators by using a twelve volt sealed lead acid rechargeable battery (not shown), though other battery configurations are certainly possible such as rechargeable lithium-ion, nonrechargeable batteries and mini fuel cells; power can also be supplied via direct connection to a power outlet, for example, when the wheelchair is left in a stationary location or the battery is charging. Said battery is held in place in a wiring and battery enclosure, located on the underside of Base 1 FIG. 3 shows a rectangle enclosure Cover 39 center front section forward of Opening 2 and the front edge between Supports 19A and 19B The battery's charge is maintained by plugging a charger into a 3 pin inline Charging Port 37 located left rear of Base 1. The Actuators are controlled by a 4 button hand Controller 21 as used on hospital beds. There are symbols by each button to show what operation it performs. Top left raises the rear of Lifting Plate 11 symbol shows seat raised lower left lowers the rear of Lifting Plate 11, symbol shows seat in lowered position top right button opens Cover 8 symbol shows cover in the open position and bottom right button closes Cover 8 symbol shows Cover 8 in the closed position. There is no wiring diagram included as any one skilled in the art of wiring can make the proper connections to make the commode function properly.

Operation of the apparatus of the present invention is both convenient and relatively maintenance-free. Referring now to FIGS. 4, 5, 6 and 7, to install the commode one removes the standard canvas seat by removing the screws which hold it to the wheelchair Seat Rail 45. Remove the lower screws on the back of the seat, in order to allow the Cover 7 to move to the rear. Pick up the unit by the front and rear and place it over the Seat Rails 45 in place of the canvas. Secure the Cushion's 17 and 18, preferably by use of the Velcro®. Insert the Waste Receptacle 13 in Grooves 20 under Base 1. Preferably, deodorant can be added at this time (for example, a cup of R/V holding tank treatment works well). This helps control odor and facilitates removal of solid waste and cleaning the receptacle. The disabled person using the device is preferably wearing handicapped clothing which opens in the rear. Transfer the disabled person to the chair, for safety they can be secured to the seat by any means determined by their physical condition. As the commode operates the slope of the seat is changed by raising the rear portion of the seat. This could effect the balance of the disabled occupant and create a fall hazard. Therefore to use the seat it is recommended that the disabled person be secured to the chair. Such safety restraints will typically be prescribed for the patent by their doctor. The type of safety device will vary depending on the patient's physical condition.

In embodiments of the present invention, the automatic operation construction is designed to enable the invalid person to operate the automated commode seat without caregiver assistance. Even the most severely disabled can use embodiments of this version and other versions of the present invention with minimal effort. Activation of Switch 21 causes the rear portion of the seat to be raised. Powering of movement is provided by operation of Activators 32A and 32B which lifts Lifting Plate 11. When the seat is in the up position, clearance is provided for Cover 8 to slide back and expose Waste Receptacle 13. The sliding action is accomplished by Switch 21 initiating operation of Actuator 31 it causes Cover 8 to move toward the rear. When Cover 8 is in its fully extended position, Receptacle 13 becomes exposed. When the patient is finished voiding or defecating, and a caregiver is available, they can remove Cushion 18 from Cover 8 while the seat is in the up position and Cushion 18 is off Cover 8. They can raise the canvas seat back and easily take care of the patient's perineal hygiene. Clean Cushion 18 and reinstall on Cover 8, close Cover 8, and then lower the seat. Remove the Waste Receptacle13, empty clean and reinstall

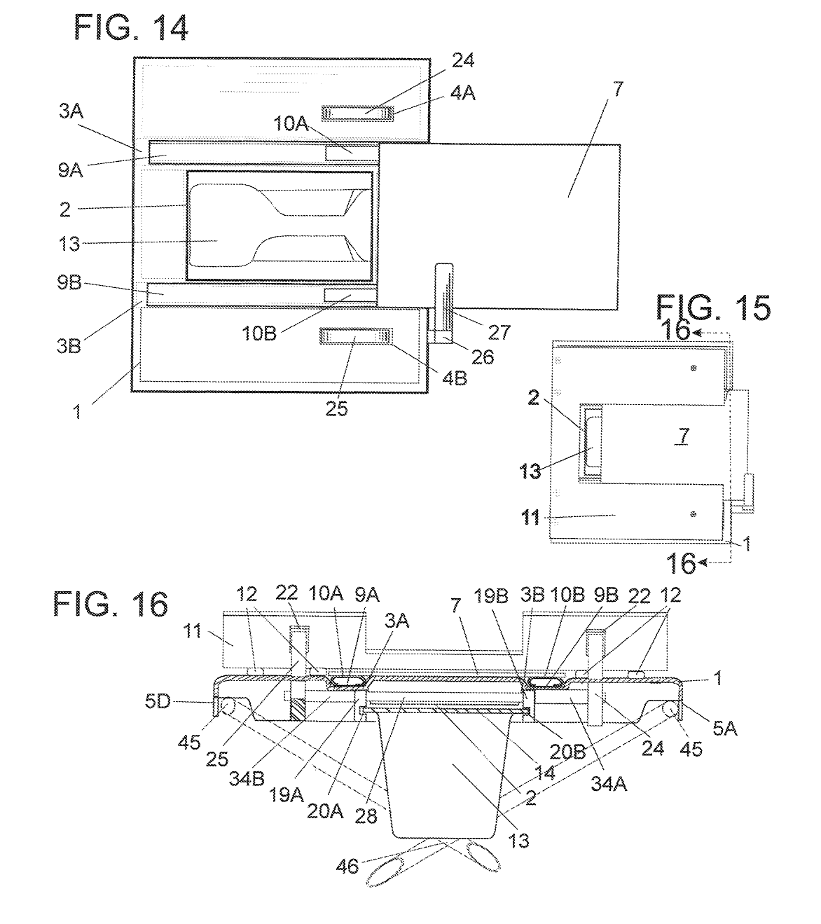

Other embodiments of the apparatus of the present invention are illustrated most clearly in FIGS. 14, 15, 16, and 17. These embodiments related to a more affordable manual version that can be used when the invalid person cannot move or help in any manner with the operation of the seat. The commode seat will usually replace the standard canvas seat of a conventional wheelchair. For convenience, the Base 1 is sized to fit on the horizontal seat Support Bars 45 of a standard wheelchair.

Base 1 is preferably molded of a fiberglass material with sufficient strength to support a person in a seated position. The edges of Base 1 are preferably angled downwardly for added structural strength. Centered in Base 1 is a rectangular molded Opening 2 the inner edge of which is formed oriented downwardly in order to add strength and to direct waste into a Waste Receptacle 13. Opening 2 is oriented extending substantially parallel to the right and left seat edges, of the proper size and location for the base to function as a conventional toilet seat. This configuration is shown best in FIG. 14.

A Groove 3A is molded horizontally and parallel to the left side of Opening 2 in the top of Base 1. A Track 9A is bolted into Groove 3A, flush with the top of Base 1. Another Groove 3B is molded, horizontally and parallel, to the right side of Opening 2 in the top of Base 1. Track 9B is bolted into Groove 3B, flush with the top of Base 1. Slides 10A and 10B slide to the rear when fully extended.

A Cover 7 is preferably fixedly attached to each sliding member 10A and 10B in an orientation extending there over. A Cover 7 is located approximately one inch short of covering Opening 2 on the front when in the closed position. This orientation is important in order to avoid injury to any person while seated in the chair. The rear of Cover 7 has a downward curved edge ending above Grooves 20A and 20B for Receptacle 13 this allows Receptacle 13 to be inserted and removed. Cover 7 extends ¾″ past Base 1 in the closed position which allows the downward portion of Cover 7 to act as a handle to slide cover 7 back when the seat is in the raised position.

Referring now to FIG. 15, a U-shaped Lifting Plate 11 is made of fiberglass and is attached to the front edge of Base 1 with Rubber Washers 12 inserted between Base 1 and Lifting Plate 11 to allow flexibility at the attachment point as the rear raises and lowers, with the open portion of the U-shaped portion oriented toward the rear. Plate 11 is about the same size as Base 1. The U-shaped portion is cut out to be capable of being vertically aligned with respect to Opening 2. A fitted Cushion 17 is attached to Plate 11 and has substantially the same configuration, when viewed from the top, as does Plate 11. Cushion 18 is of the required size and shape to fill in the open portion of the U-shaped portion and attaches to Cover 7. Both Cushions 17 and 18 are preferably made of a foam rubber padding and include a nylon covering, and can be attached by any conventional means (not shown) such as Velcro® material, or the like, in order to permit removal for transportation, cleaning or maintenance activities.

Four Notch's 5A, 5B, 5C, and 5D are cut in each lower corner of Base 1 of a size to allow Base 1 to sit on the wheelchair seat rails 45 and for the side edge of Base 1 to extend below seat rail 45 which in turn secures the Base 1 to the wheelchair in a manner were it can not slide or fall off the frame.

Support rails or members 19A and 19B can be made from substantially rectangular plastic bar material. Extending from the front to the rear of Base 1, said support members are preferably permanently affixed to the underside of Base 1 and preferably run parallel to Opening 2, said support members having Grooves 20A and 20B machined in the lower side starting at a point just below were the down ward slope of ware Opening 2 ends. Said Grooves 20A and 20B are of a size to allow the insertion of Flanges 14 of Waste Receptacle 13.

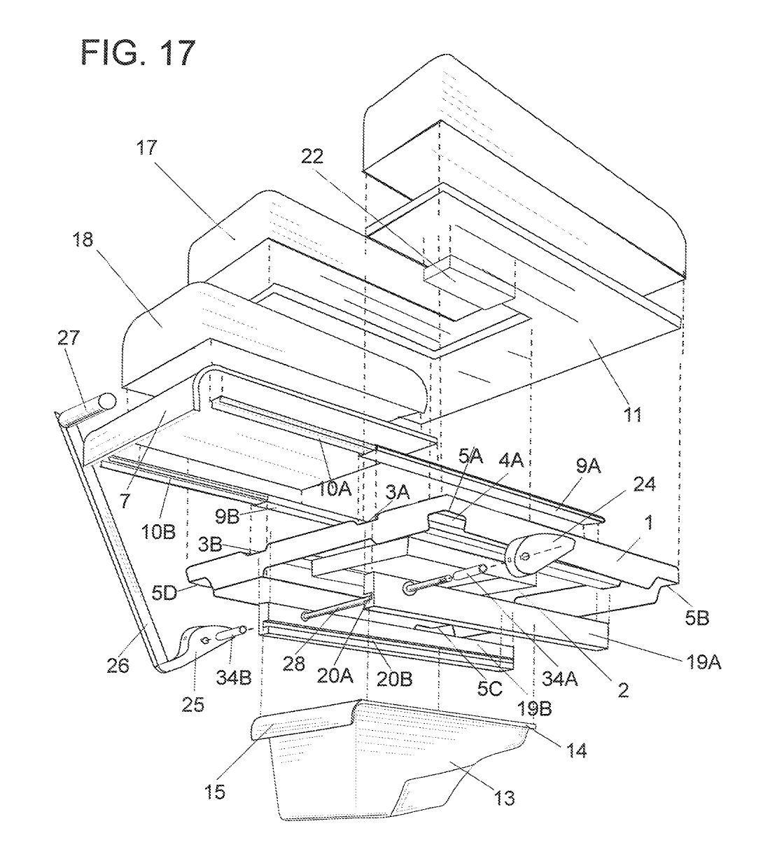

Removable Waste Receptacle 13 is preferably molded of a plastic material such as polyethylene and is shown best in FIGS. 16 and 17. Receptacle 13 has a generally rectangular shaped entrance opening on top having a width slightly greater than Opening 2 and a length starting at the front of Opening 2 and ending at the rear edge of Base 1. The outward Flanges 14 on the top permit Receptacle 13 to be temporally affixed under Opening 2 to Base 1, To allow Receptacle 13 to fit within the potentially obstructive elements of a foldable wheelchair. For example, in order accommodate the Cross Braces 46 of a conventional foldable wheelchair frame, Receptacle 13 has a stepped configuration in side view with a shallow section in the front area to permit insertion with the upper “V” of the Cross Braces 46 of the wheelchair, and a second section having a greater depth and volume starting behind the Cross Braces 46.

The operation of an embodiment of the manual wheelchair commode is accomplished by the implementing the use of a Lever 26 and Cams 24 and 25 which are attached by inserting Cam shaft 28 through Apertures in Supports 19A and 19B directly behind the rear downward edge of Opening 2 and centered between Grooves 20A and 20B and the bottom of Base 1. Apertures 4A and 4B are cut in Base 1, preferably in a location and size to allow Cam's 24 and 25 to operate by passing through Base 1 to raise Lifting Plate 11. Where Cams 24 and 25 contact Lifting Plate 11 two Wear Blocks 22A and 22B preferably made of a hard plastic material are attached to Lifting Plate 11. Cam spacer's 34A and 34B are installed on both ends of Shaft 28. Cams 34 are made with tubular material with an inner aperture of a size to allow it to slide over Cam Shaft 28 and of a length to run from Support's 19A and 19B to Cams 24 and 25 said shaft maintains Cam 24 and Cam 25 in their proper location in respect to Apertures 4A and 4B. Cams 24 and 25 are preferably constructed from aluminum, carbon fiber or other suitable metals or alloys, and are of a size and shape to raise the rear of Lifting Plate 11 to a height to allow clearance for Cover 7 to open when it is rotated, preferably by 90° . Cam 24 is attached to Shaft 28. Cam 25 is the size and shape as 24 with the addition of a lower portion which extends to a point beyond Base 1 to allow Lever 26, which is most preferably an elongated rectangular aluminum bar 16″ long, but which can be formed of any suitable material such as carbon fiber, metals or alloys, to be attached to Cam 25 in upright vertical manner behind the seat back, Handle 27 is then attached to the upper portion of Lever 26.

Referring now to FIGS. 17, 18, 19 and 20, operation of embodiments of the apparatus of the present invention is both convenient and relatively maintenance-free. To install the commode remove the standard canvas seat by removing the screws which hold it to the wheelchair Seat Rail 45. Remove the lower screws on the back of the seat, in order to allow the Cover 7 to move to the rear. Pick up the unit by the front and rear and place it over Seat Rails 45 where the canvas has been removed. Secure the Cushion's 17 and 18 by use of the Velcro®. Insert Waste Receptacle 13 under Base 1. One can add deodorant at this time (a cup of R/V holding tank treatment works well). This helps control odor and facilitates removal of solid waste and cleaning the receptacle. The disabled person must wear handicapped clothing which opens in the rear. Transfer the disabled person to the chair, for safety they should be secured to the seat by any means determined by their physical condition. As the commode operates the slope of the seat is changed by raising the rear portion of the seat. This could affect the balance of the disabled occupant and create a fall hazard. Therefore to use the seat the occupant should be secured to the chair. Safety restraints should be prescribed for the patient by their doctor. The type of device will vary depending on the patient's physical condition.

Operation of embodiments of the manual version is accomplished by a caregiver, by lowering Handle 27 located at the rear of the seat. The Handle 27 is lowered till it is in a horizontal plane and stops. This has rotated Cams 24 and 25 which in turn has elevated the seat to allow clearance for Cover 7 to be slid to the rear by pulling it out by the downward portion of Cover 7 When Cover 7 is in its fully extended position, Receptacle 13 becomes exposed thus allowing the commode to be used. When the patient is finished voiding or defecating, the caregiver can remove Cushion 18 from Cover 7 while the seat is in the up position and Cushion 18 is off Cover 7. The caregiver can raise the canvas seat back and easily take care of the patient's perineal hygiene. Clean Cushion 18 and reinstall on Cover 7, close Cover 7, and then lower the seat by raising Handle 27 to its vertical position. Then remove Waste Receptacle 13 by sliding to the rear empty clean and reinstall by inserting Waste Receptacle 13 Flange 14 into Supports 19 Grooves 20 A and 20B.

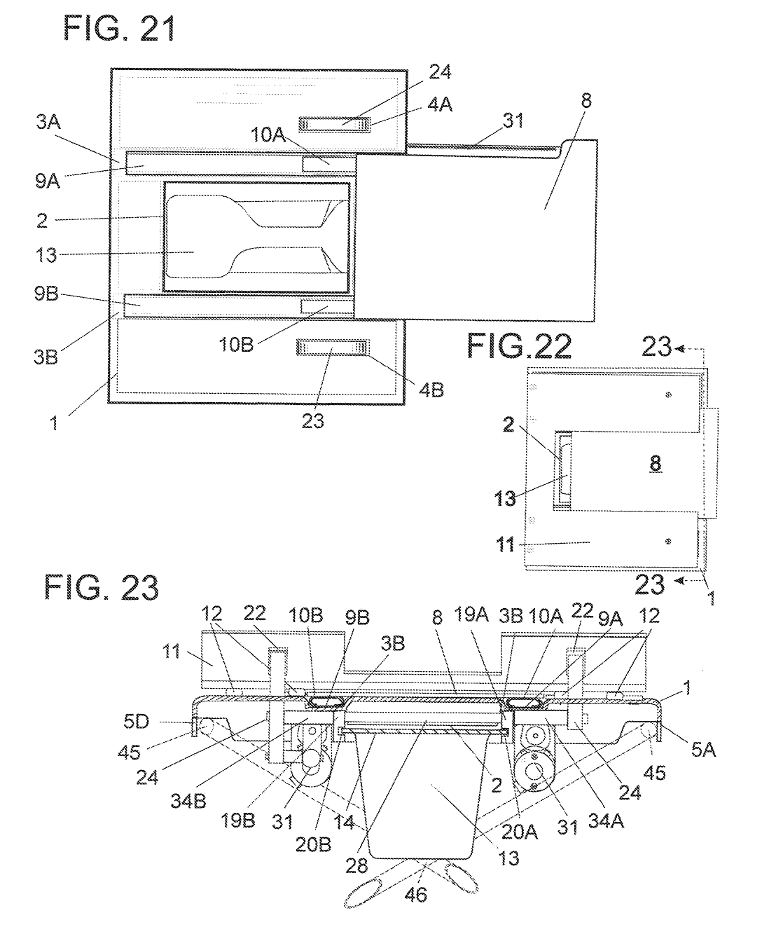

An embodiment of the apparatus of the present invention is illustrated most clearly in FIGS. 21, 22, 23 and 24. This embodiment is a means of automating embodiments of the manual version. The commode seat will usually replace the standard canvas seat of a conventional wheelchair. For convenience, the Base 1 is sized to fit on the horizontal seat Support Bars 45 of a standard wheelchair

Base 1 is preferably molded of a fiberglass material with sufficient strength to support a person in a seated position. The edges of Base 1 are preferably angled downwardly for added structural strength. Preferably centered in Base 1 is a substantially rectangular molded Opening 2, the inner edge of which is preferably formed oriented downwardly in order to add strength and to direct waste into a waste Receptacle 13. Opening 2 is preferably oriented extending substantially parallel to the right and left seat edges, of the proper size and location for the base to function as a conventional toilet seat. This configuration is shown best in FIG. 21.

A Groove 3A is molded horizontally and parallel to the left side of Opening 2 in the top of Base 1. A Track 9A is bolted into Groove 3A, flush with the top of Base 1. Another Groove 3B is molded, horizontally and parallel, to the right side of Opening 2 in the top of Base 1. Track 9B is bolted into Groove 3B, flush with the top of Base 1. Slides 10A and 10B slide to the rear when fully extended.

A Cover 8 is preferably fixedly attached to each sliding member 10A and 10B in an orientation extending there over. Cover 8 is located approximately one inch short of covering Opening 2 on the front when in the closed position. This orientation is important in order to avoid injury to any person while seated in the chair. The rear of Cover 8 has a downward curved edge ending above Grooves 20A and 20B for Receptacle 13 this allows Receptacle 13 to be inserted and removed. There is a projection on the lower right corner of the curved edge of Cover 8 in order to facilitate affixing the cylinder of Actuator 31 thereto. This cylinder provides the ability to move Cover 8 back and forth.

Referring now to FIG. 22, a U-shaped Lifting Plate 11, preferably made of fiberglass, is attached to the front edge of Base 1. Rubber Washers 12 are inserted between Base 1 and Lifting Plate 11 to allow flexibility at the attachment point as the rear raises and lowers, with the open portion of the U-shaped portion oriented toward the rear. Plate 11 is about the same size as Base 1. The U-shaped portion is cut out to be capable of being vertically aligned with respect to Opening 2. A fitted Cushion 17 is attached to Plate 11 and has substantially the same configuration, when viewed from the top, as does Plate 11. Cushion 18 is of the required size and shape to fill in the open portion of the U-shaped portion and attaches to Cover 7. Both Cushions 17 and 18 are preferably made of a foam rubber padding and include a nylon or other cloth covering, which as discussed previously can be of a bactericidal fabric or bactericidal treated fabric, and may be attached by any conventional means (not shown) such as Velcro® material, or the like, in order to permit removal for transportation, cleaning or maintenance activities.

Four Notch's 5A, 5B, 5C, and 5D are cut in each lower corner of Base 1 of a size to allow Base 1 to sit on the wheelchair Seat Rails 45 and for the side edge of Base 1 to extend below Seat Rail 45 which in turn secures the Base 1 to the wheelchair.

Support rails 19A and 19B are preferably made from elongated rectangular plastic bar material, or metals or alloys or other suitable material extending from the front to the rear of Base 1. Said support members can be permanently affixed to the underside of Basel and running parallel to Opening 2 said members to have Grooves 20A and 20B machined in the lower side starting at a point just below were the down ward slope of Opening 2 ends. Said Grooves are of a size to allow the insertion of Flanges 14 of Waste Receptacle 13.

Removable Waste Receptacle 13, is preferably molded of a plastic material such as polyethylene and is shown best in FIGS. 3 and 4, though it can of course be made of other materials such as carbon fiber, metals and alloys. Receptacle 13 has a generally rectangular shaped entrance opening on top having a width slightly greater than opening 2 and a length starting at the front of Opening 2 and ending at the rear edge of Base 1. The outward Flanges 14 on the top permit Receptacle 13 to be temporally affixed under Opening 2 to Base 1, To allow Receptacle 13 to fit within the potentially obstructive elements of a foldable wheelchair. For example, in order accommodate the cross braces of a conventional foldable wheelchair frame 46, the Receptacle 13 has a stepped configuration in side view with a shallow section in the front area to permit insertion with the upper “V” of the Cross Braces 46 of the wheelchair, and a second section having a greater depth and volume starting behind Cross Braces 46.

The operation of embodiments of the cam automated wheelchair commode is accomplished by inserting Shaft 28 through Apertures in Supports 19A and 19B directly behind the rear downward edge of Opening 2 and centered between Grooves 20A and 20 B and the bottom of Base 1. Apertures 4A and 4B are cut in Base 1 in a location and size to allow Cam 23 and Cam 24 to operate by passing through Base 1 to raise Lifting Plate 11. Where Cams 24 and 25 contact Lifting Plate 11, Wear Block's 22A and 22B, constructed of a hard plastic material, are attached to Lifting Plate 11. Cam spacer's 34A and 34B are installed on both ends of Shaft 28 Cam Spacer's 34A and 34B are made with tubular material with an inner aperture of a size to allow it to slide over Cam Shaft 28 and of a length to run from Support's 19A and 19B to Cams 23 and 24, said shaft maintains Cam 23 and Cam 24 there proper location in respect to Apertures 4A and 4B. Cam 24 is preferably constructed from aluminum (though as previously mentioned other materials such as carbon fiber, metals alloys are possible) of a size and shape to raise the rear of Lifting Plate 11 to a height to allow clearance for Cover 8 to open when Cam 23 and 24 are rotated 90°. Cam 24 is attached to Shaft 28. Cam 23 is the size and shape as 24 with the addition of a lower portion which extends to a point approximately 3″ below Shaft 28 to allow Actuator 30 cylinder to be attached to Cam 23 with the proper leverage to operate. With Cam 23 in the lowered position and Actuator 30 cylinder fully extended and attached the stationary section of Actuator 30 is attached to Support 19B forward wheelchair Cross Brace 46 Actuator 31 cylinder in the closed position is attached to the downward projection on the right corner of Cover 8 and with Cover 8 extended ½″ in back of Base 1 Actuator 31 in a parallel plane with Base 1 is attached to Support 19A at the front of the seat Base 1.

Power is preferably supplied to Actuators by using a twelve volt sealed lead acid rechargeable battery or other rechargeable battery such as lithium ion, not shown, other suitable power options are possible such as nonrechargeable batteries, mini fuel cells, or plug in power. Said battery will be held in place in a wiring and battery enclosure, located on the underside of Base 1. FIG. 3 shows a rectangular enclosure Cover 39 center front section forward of Opening 2 and the front edge between Supports 19A and 19B The battery's charge is maintained by plugging a charger into a 3 pin inline Charging Port 37 located left rear of Base 1. The Actuators are preferably controlled by a 4 button hand Controller 21 as used on hospital beds, but any suitable switch will suffice. There are symbols by each button to show what operation it performs. Top left raises the rear of Lifting Plate 11 and a symbol shows the seat raised; lower left lowers the rear of Lifting Plate 11, symbol shows the seat in the lowered position; top right button opens Cover 8 symbol shows the cover in the open position and bottom right button closes Cover 8 symbol shows the cover in the closed position. The controller is wired to the actuators to effect the controls specified hereinabove. Any one skilled in the art of wiring can make the proper connections to make the commode function properly.

Operation of the apparatus of the present invention is both convenient and relatively maintenance-free. Referring to FIGS. 4-7, to install the commode simply remove the standard canvas seat by removing the screws which hold it to the wheelchair Seat Rail 45. Remove the lower screws on the back of the seat, in order to allow the Cover 8 to move to the rear. Pick up the unit by the front and rear and place it over the Seat Rails 45 where you have removed the canvas. Secure the Cushion's 17 and 18 by use of the Velcro®. Insert the Waste Receptacle 13 under Base 1. You can add deodorant at this time (a cup of R/V holding tank treatment works well). This helps control odor and facilitates removal of solid waste and cleaning the receptacle. The disabled person should wear handicapped clothing which opens in the rear. Transfer the disabled person to the chair, for safety they should be secured to the seat by any means determined by their physical condition. As the commode operates the slope of the seat is changed by raising the rear portion of the seat. This could affect the balance of the disabled occupant and create a fall hazard. Therefore to use the seat the occupant should be secured to the chair. Safety restraints must be prescribed for the patent by their doctor. The type of device will vary depending on the patient's physical condition.

The automatic operation construction enables the disabled person to operate the automated commode seat without caregiver assistance. Even the most severely disabled can use this version of the present invention with minimal effort. Activation of Switch 21 causes the rear portion of the seat to be raised. Powering of movement is provided operation of Activator 30 which rotates Cam 23 and 24 and in turn lifts lifting plate 11. When the seat is in the up position, clearance is provided for Cover 8 to slide back and expose Waste Receptacle 13. The sliding action is accomplished by Switch 21 initiating operation of Actuator 31 it causes Cover 8 to move toward the rear. When Cover 8 is in its fully extended position, Receptacle 13 becomes exposed. When the patient is finished voiding or defecating, and a caregiver is available, they can remove Cushion 18 from Cover 8 while the seat is in the up position and Cushion 18 is off Cover 8. They can raise the canvas seat back and easily take care of the patient's perineal hygiene. Clean Cushion 18 and reinstall on Cover 8, close Cover 8, and then lower the seat. Remove the Waste Receptacle13, empty clean and reinstall.

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims.

1. A wheelchair commode comprising:
(a) a waste receptacle
(b) a seat having an opening, and
(c) a movable cover for the opening,
wherein the seat can rise via a first actuator and the cover can open via a second actuator.

2. The wheelchair commode of claim 1 wherein the seat fabric is made of a bactericidal fabric.

3. The wheelchair commode of claim 1 wherein the waste receptacle, seat and moveable cover are configured to fit in place of a wheelchair seat.

4. The wheelchair commode of claim 1 wherein perineal hygiene of the occupant can be accomplished without transferring the occupant from the wheelchair.

5. The wheelchair commode of claim 1 wherein the seat is formed of a substantially rigid material.

6. The wheelchair commode of claim 1 wherein the opening is wide enough to prevent soiling of the seat during use.

7. The wheelchair commode of claim 1 wherein the actuators are activated via an electronic control panel.

8. A wheelchair commode comprising:
(a) a waste receptacle
(b) a seat having an opening, and
(c) a movable cover for the opening,
wherein the seat can rise via a first and a second actuator and the cover can open via a third actuator.

9. The wheelchair commode of claim 8 wherein the seat fabric is made of a bactericidal fabric.

10. The wheelchair commode of claim 8 wherein the waste receptacle, seat and moveable cover are configured to fit in place of a wheelchair seat.

11. The wheelchair commode of claim 8 wherein perineal hygiene of the occupant can be accomplished without transferring the occupant from the wheelchair.

12. The wheelchair commode of claim 8 wherein the seat is formed of a substantially rigid material.

13. The wheelchair commode of claim 8 wherein the opening is wide enough to prevent soiling of the seat during use.

14. A wheelchair commode comprising:
(a) a waste receptacle
(b) a seat having an opening, and
(c) a movable cover for the opening,
wherein the seat can rise via a first cam and a second cam.

15. The wheelchair commode of claim 14 wherein the seat fabric is made of a bactericidal fabric.

16. The wheelchair commode of claim 14 wherein the waste receptacle, seat and moveable cover are configured to fit in place of a wheelchair seat.

17. The wheelchair commode of claim 14 wherein perineal hygiene of the occupant can be accomplished without transferring the occupant from the wheelchair.

18. The wheelchair commode of claim 14 wherein the seat is formed of a substantially rigid material.

19. The wheelchair commode of claim 14 wherein the opening is wide enough to prevent soiling of the seat during use.

20. The wheelchair commode of claim 14 wherein the first cam and the second cam are activated via a lever.
